(19) United States
(12) Patent Application Publication
(10) Pub. No.: US 2007/0137033 A1
(43) Pub. Date: Jun. 21, 2007

(54) Method for manufacturing a rotary member of a torque converter and a rotary member of a torque converter manufactured by the method

(75) Inventor: Ikuo Murata, Osaka (JP)

Correspondence Address: GLOBAL IP COUNSELORS, LLP, 1233 20TH STREET, NW, SUITE 700, WASHINGTON, DC, 20036-2680, US

(73) Assignee: EXEDY Corporation, Osaka (JP)

(21) Appl. No.: 10/576,775

(22) PCT Filed: Sep. 29, 2004
(86) PCT No.: PCT/JP04/14195

§ 371 Date: Apr. 21, 2006

(30) Foreign Application Priority Data
Oct. 29, 2003 (JP) 2003-369296

(51) Int. Cl. B23P 15/04

(52) U.S. Cl. 29/889.2

(57) ABSTRACT

It is an object of the present invention to cut costs in manufacturing a rotary member of a torque converter. A method for manufacturing a rotary member of a torque converter 1 is a method for includes manufacturing a rotary member 10 constituted by a turbine shell 11 of the torque converter 1, a plurality of turbine blades 13 fixed to an inner face 11a of the turbine shell 11, and a driven plate 25 of a lock-up device 7 fixed to an outer face 11b of the turbine shell 11. The method includes a first step, a second step, and a third step. In the first step, the driven plate 25 is fixed to the turbine shell 11. In the second step, the turbine blades 13 are brazed to the turbine shell 13 by heating the turbine shell 11 and the turbine blades 13. In the third step, the rotary member 10 is quenched after the heat treatment in the second step.

### TECHNICAL FIELD

The present invention relates to a method for manufacturing a rotary member of a torque converter, and particularly to a method for manufacturing a rotary member constituted by a turbine shell, a plurality of blades, and a driven plate.

Furthermore, the present invention relates to a rotary member of a torque converter manufactured by the method.

### BACKGROUND ART

A torque converter includes three kinds of vane wheels (an impeller, a turbine, and a stator) in a working oil chamber and transmits torque from an input rotary member to an output rotary member through a working oil. The turbine is connected to an output member and includes a turbine shell and a plurality of turbine blades. The turbine shell is an annular member bulging toward the front cover on the engine side. The turbine blades are disposed radially and fixed to an inner face of the turbine shell.

Torque converters having a lock-up device to prevent the loss of energy due to fluid slip has been proposed in the conventional technology (refer to Patent Document 1, for example). The lock-up device typically is disposed between the turbine shell and the front cover, and includes a piston (drive plate), a driven plate, and torsion springs. The piston is disposed near to the front cover, and is pressed against the front cover to rotate integrally when the device is actuated. The driven plate is an annular plate member for transmitting the driving force of the piston to the turbine shell. The torsion springs elastically connect the piston with the driven plate in the rotational direction.

In a torque converter having such a lock-up device, the driven plate is fixed to an outer face of the turbine shell (a surface near the front cover), and a plurality of turbine blades are fixed to an inner face of the turbine shell (a surface near to the output member) so that the turbine shell, the driven plate and the turbine blades integrally constitute one rotary member. In order to manufacture the rotary member, for example, first, the driven plate is fixed to the outer face of the turbine shell by spot welding. Next, the turbine blades are disposed on the inner face of the turbine shell with brazing material, and finally the integral member made of the turbine shell and the driven plate is heated in a furnace for brazing.

In this kind of the lock-up device, the driven plate is repeatedly pushed by the compressed torsion springs in the rotational direction when the device is engaged. Therefore, contact portions of the driven plate with which the torsion springs abut need a high strength. Conventionally, the strength of the driven plate is ensured by performing what is called induction hardening to the driven plate after the turbine blades are brazed to the turbine shell.

[Patent Document 1]

Unexamined Patent Publication H5-71612

### DISCLOSURE OF INVENTION

In the above-described conventional method for manufacturing a rotary member, the number of steps is large and the consumed energy is large, thereby increasing the cost of manufacturing.

Further, in the above-described method for manufacturing, the strength of the driven plate becomes uneven depending on portions, because the induction hardening is performed locally unlike the brazing.

Furthermore, in the above-described method for manufacturing, even if the turbine shell and the turbine blades are made of a high-tension material, a heat treatment at the brazing may cause them to lose the properties, thereby lowering durability, strength, and so on.

It is an object of the present invention to reduce costs of manufacturing a rotary member of a torque converter. It is another object of the present invention to improve the strength of the driven plate by restraining variations. It is the other object of the present invention to recover mechanical properties of the turbine shell and the turbine blades and to reduce distortion at the brazing.

According to a method for manufacturing a rotary member of a torque converter of claim 1, the rotary member includes a turbine shell of the torque converter, a plurality of blades fixed to an inner face of the turbine shell, and a driven plate of a lock-up device fixed to an outer face of the turbine shell. The method includes a first step, a second step, and a third step. In the first step, the driven plate is fixed to the turbine shell. In the second step, the turbine shell and the blades are heated so as to fix the blades to the turbine shell by brazing. In the third step, the rotary member is rapidly cooled after the second step.

According to a method for manufacturing a rotary member of a torque converter of claim 2 depending on claim 1, in the third step the rotary member is rapidly cooled immediately after the rotary member is cooled down to a certain temperature in the second step.

According to a method for manufacturing a rotary member of a torque converter of claim 3 depending on claim 1 or 2, in the second step the brazing is performed by heating such that a temperature of the rotary member reaches at least a melting point of the brazing material used for brazing, preferably up to 1100 degrees Celsius. In the third step, the rotary member is rapidly cooled when the temperature of the rotary member reaches at least an appropriate hardening temperature of the driven plate, preferably down to 850 degrees Celsius in the second step.

According to a method for manufacturing a rotary member of a torque converter of claim 4 depending on claim 3, in the third step, the rotary member is cooled down to the appropriate hardening temperature or a mechanical melting temperature (TM temperature) while keeping the temperature distribution of the rotary member within 40 to 100 degrees Celsius in order to reduce distortion.

According to a method for manufacturing a rotary member of a torque converter of claim 5 depending on any of claims 1 to 4, the turbine shell and the blades are made of ultra low-carbon steel.

According to a rotary member of a torque converter of claim 6 is manufactured by the method according to any of claims 1 to 5.

### BRIEF DESCRIPTION OF DRAWINGS

FIG. 1 is a fragmentary sectional view of a torque converter including a rotary member of one embodiment according to the present invention.

FIG. 2 is a view explaining an overview of a method for manufacturing a rotary member of a torque converter of one embodiment according to the present invention.

### EXPLANATIONS OF LETTERS OR NUMERALS

1 torque converter
7 lock-up device
10 rotary member
11 turbine shell
11a inner face
11b outer face
13 turbine blades
25 driven plate

### BEST MODE FOR CARRYING OUT THE INVENTION

[A Rotary Member of a Torque Converter]

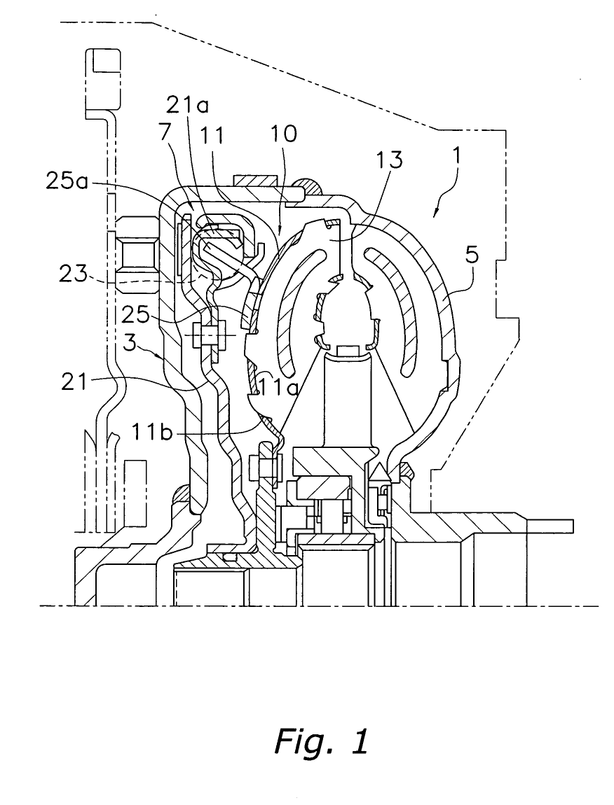

FIG. 1 shows a torque converter 1 having a rotary member 10 of one embodiment according to the present invention.

The torque converter 1 is provided for transmitting torque from a crankshaft (not shown) of the engine to a main drive shaft (not shown) of the transmission, and includes a front cover 3, an impeller 5, the rotary member 10, and a lock-up device 7.

The rotary member 10 is composed of a turbine shell 11, a plurality of turbine blades 13, and a driven plate 25 which is also an element of the lock-up device 7. The turbine shell 11 is an annular member made of ultra low-carbon steel (carbon steel having 0.15% of the largest carbon content, referred to as SPHC hereinafter). The turbine shell 11 bulges at an area between a radially outer portion and a radially inner portion thereof toward the front cover 3, and has an inner face 11a facing the impeller 5 and an outer face 11b facing the front cover 3. The turbine blades 13 are plate members made of the ultra low-carbon steel like the turbine shell 11. Each of the turbine blades 13 is radially arranged in the circumferential direction on the inner face 11a of the turbine shell 11 and is fixed to the turbine shell 11 by brazing as later described. The driven plate 25 is an annular member made of S35C, which is fixed to the outer face 11b of the turbine shell 11 by spot welding as later described. At a radially outer portion of the driven plate 25 is formed a plurality of claws 25a extending toward the front cover 3 to support the torsion springs 23 (later described) of the lock-up device 7 in the circumferential direction.

The lock-up device 7 is provided to transmit directly torque from the crankshaft (not shown) to the main drive shaft, and includes a piston 21, a plurality of torsion springs 23, and the driven plate 25. The piston 21 is disc-like member having a radially outer portion that is brought into contact with the front cover 3 for integral rotation. At a radially outer portion of the piston 21 are formed protrusions 21a extending toward the turbine shell 11 to support the torsion springs 23 in the circumferential direction with the claws 25a of the driven plate 25. The torsion springs 23 are provided to connect elastically the piston 21 with the driven plate 25 in the rotational direction, and each of them has both ends in the circumferential direction supported by the claws 25a and the protrusions 21a.

[Method for Manufacturing a Rotary Member of a Torque Converter]

Next, a description is made on a method for manufacturing a rotary member of a torque converter according to the present invention.

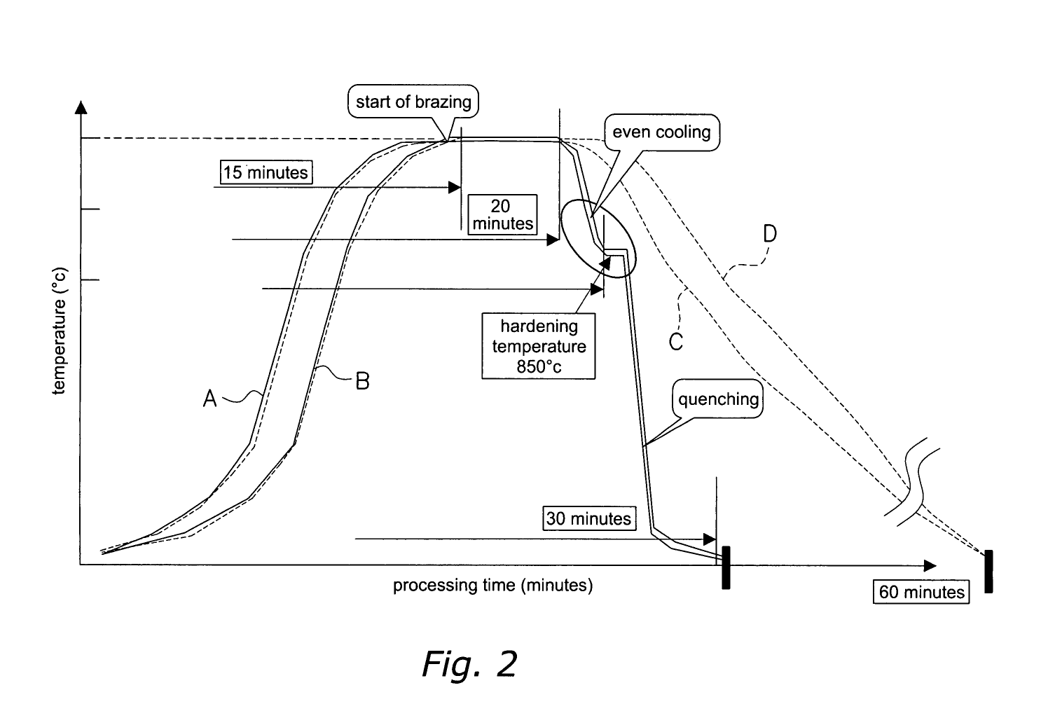

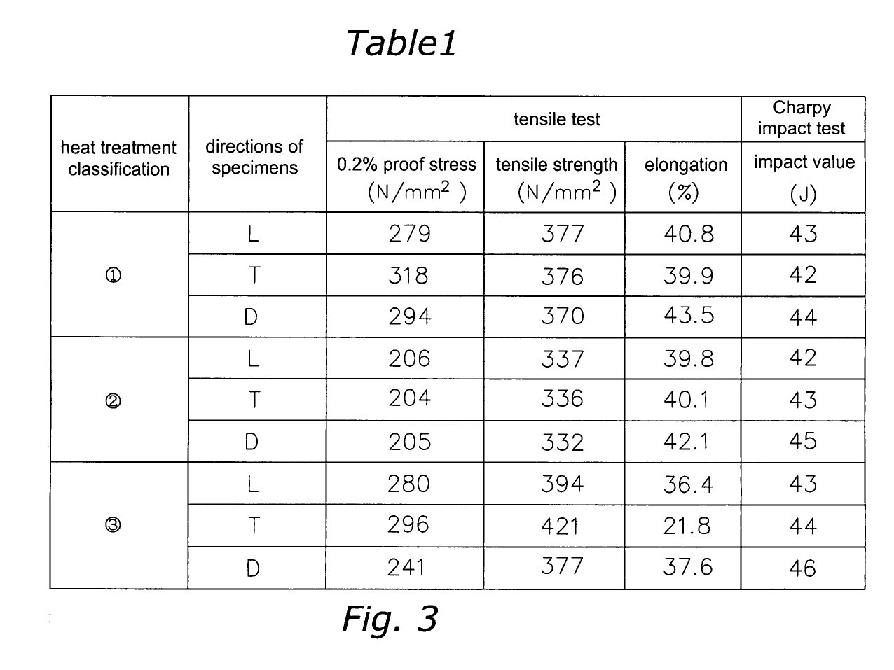

FIG. 2 shows an overview of the method for manufacturing a rotary member of a torque converter of one embodiment according to the present invention. It is noted that in the figure, curves shown in solid lines indicate temperature changes in the method for manufacturing according to the present invention. More specifically, curve A indicates temperature changes in the outer face 11b of the rotary member 10, and curve B indicate temperature changes in the inner face 11a of the rotary member 10. In addition, curves shown in dotted lines indicate temperature changes in the conventional method for manufacturing. More specifically, curve C indicates temperature changes in the outer face of the rotary member, and curve D indicates temperature changes in the inner face of the rotary member.

The method for manufacturing is a method for manufacturing the above-described rotary member 10, and includes a first step, a second step, and a third step.

In the first step, the driven plate 25 is fixed to the outer face 11b of the turbine shell 11 by spot welding. The spot welding is performed by a well-known method.

In the second step, an integral member made of the turbine shell 11 and the turbine blades 13 is heated so that the turbine blades 13 are fixed to the turbine shell 11 by brazing. In the brazing, more specifically, the turbine blades 13 are radially disposed on the inner face 11a of the turbine shell 11 equidistantly in the circumferential direction, and then brazing materials having Copper as a main element (brazing copper having a melting point of 1083 degrees Celsius) are disposed between the turbine blades 13 and the turbine shell 11, and finally the turbine shell 11 and the turbine blades 13 are heated in a furnace. As a brazing material, brazing aluminum, having a melting point of 650 degrees Celsius, may be used other than the brazing copper, for example. It is noted that the furnace used in this embodiment may have any process system of a batch system, a conveyance system or the like.

In the second step, first, the furnace is heated for about 15 minutes at least up to a melting point of the brazing material for brazing, preferably to 1100 degrees Celsius. Then, brazing is performed by maintaining the highest temperature of the rotary member 10 for 5 minutes after the temperature reaches the highest point. Finally, the furnace is slowly cooled by stopping heating down to an appropriate hardening temperature for the hardening of the driven plate 25, preferably to 850 degrees Celsius. At this time, the rotary member 10 is evenly cooled so as to restrain variations of the temperature at portions in the furnace. Slow cooling of the rotary member 10 in the furnace is kept so as to keep the temperature distribution of the rotary member 10 (variations of the temperature at each portions) within 100 degrees Celsius (preferably within 40 degrees Celsius). As a temperature control method in the slow cooling, for example, there is a method of shielding radiant heat from the furnace or a method of rotating the rotary member 10, when the rotary member 10 is conveyed out of the furnace for cooling.

In the third step, the rotary member 10 is hardened by quenching or rapid cooling after the slow cooling in the second step. In the quenching, specifically, when the temperature of the rotary member 10 reaches an appropriate hardening temperature, the rotary member 10 is taken out from the furnace, and the rotary member 10 is immersed in a bath for quenching. The bath used in this embodiment includes a water bath, a salt bath, and so on, but is not limited at all. The quenching is finished in about ten minutes after the start of the slow cooling in the second step. It is noted that in FIG. 2, curves A and B have flat portions (portions surrounded by a circle in the figure), which are maintaining times for maintaining the rotary member 10 at the appropriate hardening temperature, preferably at 850 degrees Celsius, in order to prevent variations of the temperature over the whole of the rotary member 10. The maintaining time may be several minutes or substantially zero minute.

According to the above method, the driven plate 25 is quenched together as a part of the rotary member 10 for hardness. As a result, it is unnecessary to perform separately induction hardening after the brazing on the claws 25a, with which the torsion springs 23 repeatedly abuts when the lock-up device 7 is engaged, thereby omitting the number of steps as to manufacturing the rotary member 10.

Further, according to the above method, since the quenching is performed after the heat treatment in the second step, the loss of energy can be decreased by utilizing an amount of heat in the brazing. As a result, it is possible to reduce the cost of manufacturing by energy-saving effects.

Furthermore, according to the above method, the whole of the driven plate 25 is quenched, and strength and durability of the driven plate 25 are improved.

Typically, the turbine shell 11 and the turbine blades 13 are made of a high-tension material as descried above so that the heat treatment at the brazing deteriorates durability, strength, or resistance to fatigue. In contrast, according to the method of the present invention, since the whole of the rotary member 10 is quenched, it is possible to recover the deteriorated mechanical properties, even if they are made of the ultra low-carbon steel. As a result, it is unnecessary to take measures to enlarge the thickness in order to compensate for strength and other properties of the turbine blades 13, for example.

### EXAMPLE

According an example, the present invention is described in detail below.

Here, according the following procedure, regarding the turbine shell and the turbine blades of the rotary member manufactured by the method for manufacturing according to the present invention, a degree of recovery of the properties is evaluated.

First, two test specimens (a tensile test specimen and an impact test specimen) were formed of material (SPHC), which were the same as those of the turbine shell and the turbine blades. The tensile test specimen was No. 5 tensile test specimen (thickness: 1.49 to 1.59 mm) formed according to JIS Z 2201. The impact test specimen was 2V test specimen (three-ply thickness: 4.75 to 4.87 mm) formed according to JIS Z 2202.

Next, three processes were performed on each of the test specimens: 1) no heat treatment was performed; 2) only brazing was performed; and 3) hardening was performed in addition to the brazing. In the hardening of 3), tempering was performed too.

In the brazing process, each of the test specimens was located in the furnace, was maintained at 1100 degrees for five minutes for heat treatment, then was slowly cooled. In this example, the brazing solder was not used to the test specimen in practice but only the heat treatment was performed.

In the hardening process, after the slow cooling in the brazing, each of the test specimens was immersed into the bath for quenching when the temperature reaches 850 degrees Celsius. The tempering after the hardening was performed by locating each of the test specimens in the furnace and maintaining it at 180 degrees Celsius for 1.5 hours.

After the above processes, a tensile test and Charpy impact test were done to each of the test specimens to measure 0.2% proof stress, tensile strength, elongation, and impact value in three directions (an axial direction L, a perpendicular direction T, and 45 degree direction D). It is noted that test methods of the tensile test and Charpy impact test and methods for measuring 0.2% proof stress, tensile strength, elongation, and impact value were done according to known methods.

These measurement results are shown in Table 1.

### Table 1

As shown in Table 1, the test specimen, which was hardened as well, showed the following results compared to the test specimen, which was only brazed: 0.2% proof stress and the tensile strength were increased; the elongation is restrained; and the result in the Charpy impact test was improved. As a result, according to the method for manufacturing a rotary member in the present invention, it is understood that mechanical properties of the turbine shell and the turbine blades once deteriorated by the brazing are recovered.

### Other Embodiments

(a) Material properties of the turbine shell, the turbine blades, the driven plate, and the brazing solder are not limited to those described in the embodiment.

(b) In the method for manufacturing described above, various conditions such as temperature and the heating time of the rotary member do not have to be exactly the same as those described above.

(c) A method for fixing the driven plate to the turbine shell is not limited to the spot welding.

(d) In the above method for manufacturing, in the second step, the rotary member 10 may be cooled slowly down to a mechanical melting temperature (in the range between 700 to 800 degrees Celsius, preferably at 730 degrees Celsius), not to the appropriate hardening temperature, and in the third step, the rotary member 10 may be quenched at a time when reaching the temperature.

1. A method for manufacturing a rotary member of a torque converter, the rotary member including a turbine shell of the torque converter, a plurality of blades fixed to an inner face of the turbine shell, and a driven plate of a lock-up device fixed to an outer face of the turbine shell, the method comprising:
fixing the driven plate to the turbine shell;
heating the turbine shell and the blades to fix the blades to the turbine shell by brazing; and
rapidly cooling the rotary member after heating the turbine shell.

2. The method for manufacturing a rotary member of a torque converter according to claim 1, wherein rapidly cooling the rotary member includes the rotary member being rapidly cooled immediately after the rotary member is cooled down to a certain temperature after heating the turbine shell and blades.

3. The method for manufacturing a rotary member of a torque converter according to claim 2, wherein the brazing is performed by heating such that a temperature of the rotary member reaches at least a melting point of the brazing material used for brazing, and
rapidly cooling the rotary member includes the rotary member being rapidly cooled when the temperature of the rotary member reaches an appropriate hardening temperature of the driven plate after heating the turbine shell and blades.

4. The method for manufacturing a rotary member of a torque converter according to claim 3, wherein rapidly cooling the rotary member includes the rotary member being cooled down to the appropriate hardening temperature or a mechanical melting temperature while keeping the temperature distribution of the rotary member within 100 degrees Celsius.

5. The method for manufacturing a rotary member of a torque converter according to claim 4, wherein the turbine shell and the blades are made of ultra low-carbon steel.

6. A rotary member of a torque converter manufactured by the method according to claim 5.

7. The method for manufacturing a rotary member of a torque converter according to claim 3, wherein the turbine shell and the blades are made of ultra low-carbon steel.

8. The method for manufacturing a rotary member of a torque converter according to claim 2, wherein the turbine shell and the blades are made of ultra low-carbon steel.

9. The method for manufacturing a rotary member of a torque converter according to claim 1, wherein the brazing is performed by heating such that a temperature of the rotary member reaches at least a melting point of the brazing material used for brazing, and
rapidly cooling the rotary member includes the rotary member being rapidly cooled when the temperature of the rotary member reaches an appropriate hardening temperature of the driven plate after heating the turbine shell and blades.

10. The method for manufacturing a rotary member of a torque converter according to claim 9, wherein rapidly cooling the rotary member includes the rotary member being cooled down to the appropriate hardening temperature or a mechanical melting temperature while keeping the temperature distribution of the rotary member within 100 degrees Celsius.

11. The method for manufacturing a rotary member of a torque converter according to claim 10, wherein the turbine shell and the blades are made of ultra low-carbon steel.

12. The method for manufacturing a rotary member of a torque converter according to claim 9, wherein the turbine shell and the blades are made of ultra low-carbon steel.

13. The method for manufacturing a rotary member of a torque converter according to claim 4, wherein the turbine shell and the blades are made of ultra low-carbon steel.

14. A rotary member of a torque converter manufactured by the method according to claim 1.
